(19) United States
(12) Patent Application Publication
(10) Pub. No.: US 2011/0088727 A1
(43) Pub. Date: Apr. 21, 2011

(54) AIR DUCT CLEANING SYSTEM AND METHOD

(76) Inventor: Daniel J. Slowe, Norwood, MA (US)

(21) Appl. No.: 12/579,556

(22) Filed: Oct. 15, 2009

(51) Int. Cl. B08B 9/035

(52) U.S. Cl. 134/21; 15/300.1; 15/104.05

(57) ABSTRACT

An improved system and method for cleaning air ductwork is provided that includes an air flow device and flexible tubing that is attached at one end to the air flow device and has at the other end an end cap designed to allow forced air to exit in a manner such that debris can be blown through an air duct. A vent cover and vacuum for removing the debris as it exits the air duct are also included. In addition, an exhaust extension that can be attached to an exhaust port of a shop vacuum allowing vacuumed particulates to be removed from a building is also included.

### CROSS-REFERENCE TO RELATED APPLICATIONS

None.

### STATEMENT REGARDING FEDERALLY SPONSORED RESEARCH OR DEVELOPMENT

Not applicable.

### FIELD OF THE INVENTION

This invention is in the air duct cleaning field.

### BACKGROUND OF THE INVENTION

According to the U.S. EPA, poor indoor air quality is a major reason for sickness. Studies conducted by the EPA indicate that levels of air pollutants indoors can be 100 times higher than outdoors. The average human breathes approximately 22,000 liters of air per day and, of that, 17,600 liters are from indoor air. One source of poor indoor air quality can be dust and other material in air ducts of heating and air conditioning systems. The interiors of air duct systems in residential and commercial buildings are often coated with dust. Even new homes have air ducts that have saw dust, sheetrock dust, plaster dust and the like in them. Forced air heating and air conditioning systems will circulate much of this dust through a building unless the air ducts are properly cleaned out.

Keeping air ducts clean results in better indoor air quality by reducing the airborne particulates. Keeping air ducts clean also results in better air flow through the ducts, which creates a more efficient system because the air flows more freely and evenly.

Existing protocols for cleaning air ducts generally involve commercially sold systems with air supplied by large air compressors and vacuum systems that are often powered with a truck mounted unit. These systems can be very expensive and are typically sold to companies that are in the business of duct cleaning, not to homeowners or small building owners. Thus, the majority of the air duct cleaning systems are not affordable for individuals, and the high cost of these systems means that even the service can be expensive.

Therefore, there is a need for a cost effective option for cleaning air duct systems. There is also a need for an air duct cleaning system that home and building owners can own and operate themselves so that air ducts can be cleaned more often.

Accordingly, it is an object of the invention to provide an inexpensive and effective system for cleaning air ducts.

### BRIEF SUMMARY OF THE INVENTION

The present invention includes an air duct cleaning system and method that includes flexible tubing adapted to be attached to an air flow device, such as a leaf blower, on one end and has an end cap on the other end. The end cap and flexible tubing are designed to cause forced air to loosen and blow dust and debris through the air duct. The system can also include a vacuum, such as a HEPA vacuum or a shop vacuum, and a cover that can be placed over an air duct vent, preventing dust and debris from entering the living area as it is removed from the air duct and allowing the dust and debris to be collected and/or removed by the vacuum. Another aspect of the invention is an exhaust extension that can be attached to the exhaust port of a shop vacuum and vented to the exterior of a building, thereby removing particulates from the interior of the building.

### BRIEF DESCRIPTION OF THE DRAWINGS

FIG. 1 depicts an embodiment in accordance with the invention in use in an air duct.

FIG. 2 is a detailed view of an end cap and tubing in accordance with embodiments of the invention.

FIG. 3 shows a vent cap in accordance with an aspect of the invention.

FIG. 4 depicts an exhaust attachment in accordance with another aspect of the invention.

### DETAILED DESCRIPTION OF THE INVENTION

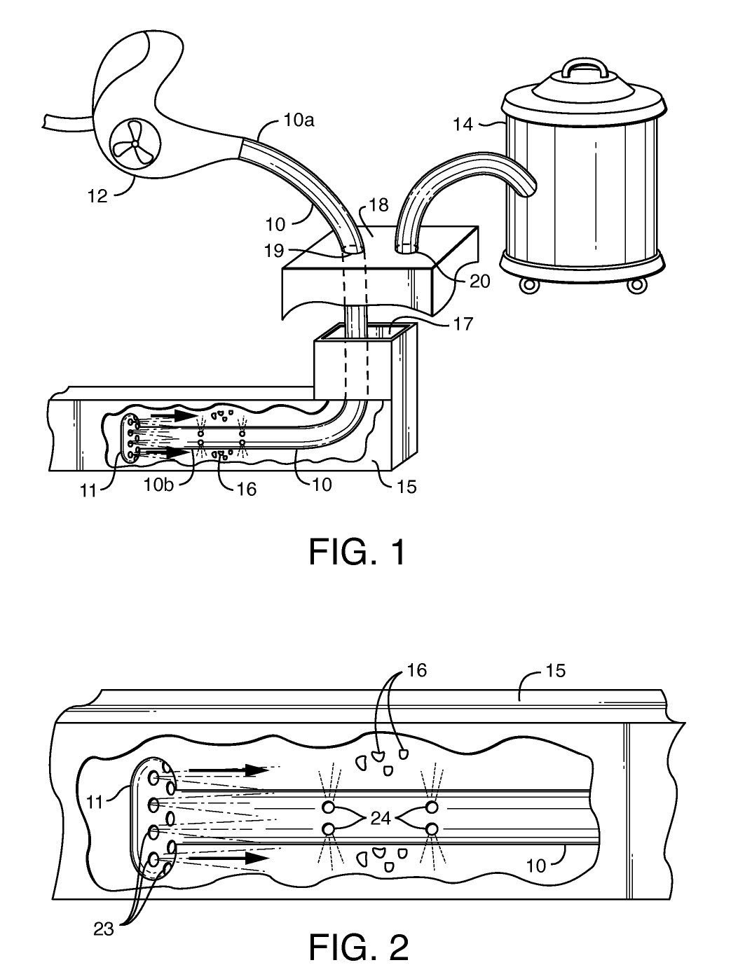

Referring to FIG. 1, an embodiment of the invention includes flexible tubing 10 with an end cap 11 on one end 10b and an attachment mechanism on the other end 10a, an air flow device 12, vent cover 18, and vacuum source 14.

Flexible tubing 10, which can be made of a suitable material such as flexible plastic, rubber, or a combination of flexible plastic and rubber, is of any length needed for cleaning an air duct. In many situations, approximately thirty feet of flexible tubing will be sufficient. Flexible tubing 10 can be from about one inch in diameter up to about three inches or more in diameter, and preferably is about two inches in diameter, and is designed on one end 10a to be attached to an air flow device. Any suitable attachment mechanism that will provide a sufficient connection so that air from the air flow device will be forced through the flexible tubing can be used. Such mechanisms include tubing with an end designed to connect to the outlet of a particular air flow device so that that end snaps, twists, or is otherwise held together with the outlet of the air flow mechanism. Other suitable mechanisms include securing the tubing to the air flow device with a clamp, by interference or press fitting, which may also involve securing the tubing to the air flow device with a strap, through use of a screw thread connection, or other connective mechanisms. The air flow device can be any suitable device that can be used to cause air to be moved through flexible tubing, such as a leaf blower.

End 10b of flexible tubing 10 has an end cap 11, which is shown in detail in FIG. 2. End cap 11 can be constructed of any suitable material, such as rubber or plastic, and is designed to redirect the air supplied by air flow device 12 in the opposite direction as this air exits. Openings 23 of end cap 11 are oriented to cause the air traveling toward end cap 11 to exit end cap 11 in generally the opposite direction (as indicated by arrows in FIG. 1). These openings 23 could be any shape and size to allow a sufficient amount of air to exit the end cap 11 and blow dust and debris through an air duct.

Flexible tubing 10 includes openings 24 (shown in FIG. 2) positioned toward end 10b that allow air to exit flexible tubing 10 in a direction generally perpendicular to flexible tubing 10. Openings 24 could be any shape and could be various sizes depending on how many were present. In one embodiment, about fifteen openings of 0.1 square inches each are present.

Referring to FIGS. 1 and 2, when flexible tubing 10 is in an air duct 15 and air is forced through flexible tubing 10 by air flow device 12, air exiting openings 24 in the flexible tubing 10 will loosen and disturb materials 16 and air exiting openings 23 will force materials 16 through air duct 15. The length of air duct 15 can be cleaned in this manner by first placing flexible tubing 10 into air duct 15 as far as it can go so that end cap 11 is at or near the end of the air duct and turning on air flow device 12. Then, as end cap 11 and flexible tubing 10 are retracted, materials 16 are blown toward vent opening 17.

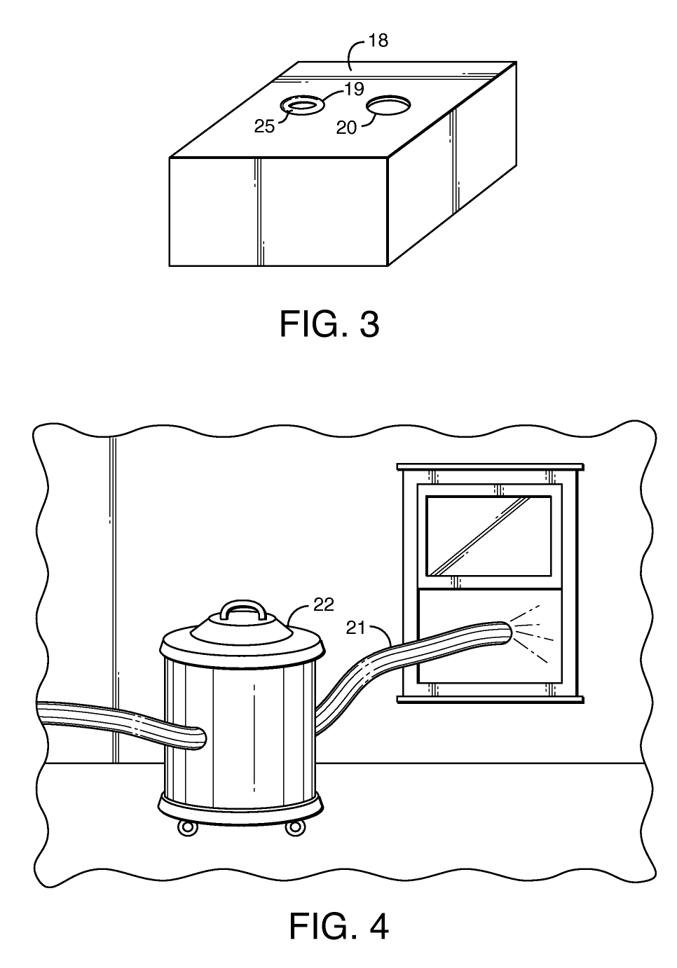

To prevent the materials 16 from being blown out of air duct 15 and entering a living area or otherwise escaping during cleaning, a vent cap 18 is used to cover vent opening 17 of air duct 15. Vent cap 18 is constructed from hard plastic or other suitable material and has two access points, air flow access 19 and vacuum access 20 as shown in FIGS. 1 and 3. Flexible tubing 10 can be inserted through air flow access 19 and drawn back through air flow access 19 during a cleaning operation as flexible tubing 10 is retracted. Air flow access 19 can be fitted with a rubber flange 25 in FIG. 3 or similar mechanism to facilitate smooth retraction of the flexible tubing while also reducing the chance of particulates escaping. Vacuum source 14 is connected to vacuum access 20 so that materials 16 can be removed as they exit air duct 15 during cleaning.

The vacuum source 14 can be a HEPA vacuum, a central vacuum system, or a shop vacuum 22 with an exhaust attachment 21 vented to the outside of a building. The exhaust attachment 21 on the shop vacuum 22 is an attachment that is added onto the exhaust port of the shop vacuum 22. The exhaust can then be vented to the exterior of the house or building. Exhaust attachment 21, as shown in FIG. 4, can be plastic, rubber, or other material such that this attachment is hollow in the center, such as a hose or tubing. Exhaust attachment 21 can be attached at one end to the exhaust port of a shop vacuum 22. The other end of exhaust attachment 21 is placed outside the building. In this way, particulates that are not filtered by the shop vacuum 22 are not returned to the interior of the building. The exhaust attachment 21 can be used in various situations, in addition to air duct cleaning, in which it is desirable to remove particulates from an area being vacuumed.

In an air duct cleaning operation, referring again to FIG. 1, end 10b of flexible tubing 10 with end cap 11 is inserted into an air duct 15 as far as it will go. Then end 10a of flexible tubing 10 is inserted through air flow access 19 of vent cap 18 and connected to air flow device 12. Vent cap 18 is placed over vent opening 17 of air duct 15, and vacuum source 14 is connected to vacuum access 20 of vent cap 18. Then, with air flowing from air flow device 12, the flexible tubing 10 is slowly pulled back through air duct 15 and materials 16 are moved toward vent opening 17. As materials 16 reach vent opening 17, the vacuum source 14 that is attached to the vent cap 18 will remove materials 16. If the vacuum source 14 is a HEPA vacuum, the particulates will be filtered. If the vacuum source 14 is a shop vacuum, exhaust attachment 21 can be used to remove the particulates from the indoor area. After the flexible tubing 10 is removed from the air duct 15, any remaining debris in the vent cap 18 can be vacuumed and the vent opening 17 and the vent diffuser can be cleaned by hand using water mixed with an antibacterial surfactant. The system can also be used to provide a mist of an antibacterial application to the interior of the air ducts upon the completion of the cleaning procedures. This application would disinfect the interior of the ducts of germs and bacteria.

Having described the invention with a certain degree of particularity, it is clear that changes can be made in the details of the invention without departing from the spirit and scope of the invention. The invention is not limited to the embodiments provided, but is to be limited only by the scope of the claims.

1. A system for cleaning air ducts comprising:
an air flow device;
a length of tubing that has a first end capable of being connected to the air flow device and a second end that includes an end cap, wherein the end cap has one or more openings designed to allow air to exit the end cap in a direction back along the tubing and wherein the tubing has openings near the second end designed to allow air to exit generally perpendicular to the tubing;
a vacuum source; and
a vent cap with a first port for allowing the tubing to pass through and a second port that the vacuum source can be connected to, wherein the vent cap is designed to be placed over a vent opening of an air duct.

2. The system of claim 1 wherein the air flow device is a leaf blower.

3. The system of claim 1 wherein the tubing is flexible and has a diameter of greater than about one inch.

4. The system of claim 3 wherein the tubing has a diameter of not more than about three inches.

5. The system of claim 1 wherein the vacuum source is a HEPA vacuum.

6. The system of claim 1 wherein the vacuum source is a central vacuum system.

7. The system of claim 1 wherein the vacuum source is a shop vacuum.

8. The system of claim 7 wherein the shop vacuum includes an exhaust attachment comprising a hose connected to an exhaust port of the shop vacuum.

9. The system of claim 2 wherein the leaf blower is an electric leaf blower.

10. An apparatus for use in cleaning air ducts comprising:
an air flow device;
a vacuum source;
flexible tubing that has a first end capable of being attached to the air flow device;
an end cap attached to a second end of the flexible tubing wherein the end cap has one or more openings designed to cause forced air to exit the end cap and flow generally in a direction back along the flexible tubing; and
a cover designed to be placed over a vent opening of an air duct that is capable of allowing the flexible tubing to pass through and being connected to the vacuum source while preventing particulate matter from escaping.

11. The apparatus of claim 10 wherein the air flow device is a leaf blower.

12. The apparatus of claim 11 wherein the vacuum source is selected from the group consisting of a HEPA vacuum, a shop vacuum, and a central vacuum system.

13. The apparatus of claim 11 wherein the flexible tubing has a diameter of between about one inch and about three inches.

14. A method of cleaning air ducts comprising the steps of:
passing a first end of a flexible tubing through a vent cap designed to cover a vent opening of an air duct;
inserting through a vent opening and into an air duct in a building a second end of the flexible tubing with an end cap attached wherein the end cap has one or more openings designed to allow air to exit in a direction back towards the vent opening and the flexible tubing has openings toward the second end that allow air to exit radially away from the flexible tubing;
attaching the first end of the flexible tubing to an air flow device;
placing the vent cap over the vent opening of the air duct;
connecting a vacuum source to the vent cap;
forcing air by use of the air flow device through the flexible tubing and out of the openings of the flexible tubing and out of the openings of the end cap;
vacuuming the vent opening by use of the vacuum source; and
retracting the flexible tubing from the air duct while the air flow device and vacuum source continue to operate.

15. The method of claim 14 wherein the air flow device is a leaf blower.

16. The method of claim 15 wherein the vacuum source is a shop vacuum.

17. The method of claim 16 further comprising the step of:
attaching a first end of an exhaust extension to an exhaust port of the shop vacuum; and
placing a second end of the exhaust extension outside of the building.

18. The method of claim 14 further comprising the steps of:
removing the vent cap after the flexible tubing has been retracted;
vacuuming the vent cap;
cleaning the vent opening using water mixed with an antibacterial surfactant; and
spraying the air duct with a mist of an antibacterial application.

19. A method for preventing particulates from re-entering an indoor air environment during vacuuming comprising the steps of:
attaching a first end of a tubing to an exhaust port of a shop vacuum;
placing a second end of the exhaust extension tubing external to the indoor air environment; and
operating the shop vacuum.

20. A device for use in conjunction with a system for removing materials from air ducts comprising:
a length of tubing with a proximal end and a distal end wherein the proximal end is designed to be connected to an air flow device and the distal end includes a cap structure that includes one or more openings arranged to allow air to exit generally back in a direction toward a more proximal portion of the tubing.

21. The device of claim 20 further wherein the tubing includes openings near the distal end that allow forced air to exit radially from the tubing.

22. The device of claim 20 wherein the proximal end of the tubing is designed to be connected to a leaf blower.
